(19) United States
(12) Patent Application Publication
(10) Pub. No.: US 2023/0062014 A1
(43) Pub. Date: Mar. 2, 2023

(54) IMAGE PROCESSING DEVICE, IMAGE PROCESSING METHOD, AND LEARNING SYSTEM

(71) Applicant: DENSO TEN Limited, Kobe-shi (JP)

(72) Inventors: Ryusuke SEKI, Kobe-shi (JP); Yasutaka OKADA, Kobe-shi (JP); Yuki KATAYAMA, Kobe-shi (JP); Rei HIROMI, Kobe-shi (JP); Aoi OGISHIMA, Tokyo (JP); Toyoshige KIDO, Kobe-shi (JP)

(73) Assignee: DENSO TEN Limited, Kobe-shi (JP)

(21) Appl. No.: 17/698,145

(22) Filed: Mar. 18, 2022

(30) Foreign Application Priority Data
Aug. 31, 2021 (JP) 2021-141513
Nov. 26, 2021 (JP) 2021-191767

(51) Int. Cl. G06V 10/764; G06T 11/00; G06V 10/26; G06V 20/20

(52) U.S. Cl. CPC G06V 10/764; G06T 11/001; G06V 10/26; G06V 20/20

(57) ABSTRACT

An image processing device for generating learning data that is used for machine learning includes a processor that obtains image data. The processor specifies an unprocessable region that is a region in which a predetermined process cannot be performed or a region in which the predetermined process is not performed in an image region of the image data, and generates image data on which the predetermined process is performed in a region except the unprocessable region in the image region, as the learning data.

### CROSS-REFERENCE TO RELATED APPLICATIONS

This nonprovisional application claims priority under 35 U.S.C. § 119(a) on Patent Application Nos. 2021-141513 filed in Japan on Aug. 31, 2021 and 2021-191767 filed in Japan on Nov. 26, 2021, the entire contents of which are hereby incorporated by reference.

### BACKGROUND OF THE INVENTION

### Field of the Invention

The present invention relates to a technique for performing machine learning using image data.

### Description of Related Art

Conventionally, in learning using deep learning of a model for performing image recognition such as image classification or object detection, a method called data augmentation is used (see, for example, JP-A-2020-166397). In the data augmentation, color tone conversion or affine transformation are applied at random to image data that is used for learning. As the data augmentation is performed, the number of various learning data can be increased. As a result, overtraining of the model can be suppressed.

### SUMMARY OF THE INVENTION

In the data augmentation when performing learning, it is typical to give perturbation to color, brightness, contrast, and the like at random in a predefined range uniformly for the entire region of image data. However, in object recognition, color information may be important. In this case, when color perturbation is uniformly given to the entire region of the image data by the data augmentation, information important for the object recognition may be lost by the data augmentation. As a result, the model after learning using the learning data obtained by the data augmentation may cause deterioration in object recognition performance.

In addition, in a conventional method, for example, how much extent image brightness should be changed by the data augmentation is selected at random within a predesigned value range. Therefore, the data augmentation may generate an image with little possibility of occurrence by, for example, further lowering brightness of a dark image. Such the image may cause deterioration in image recognition performance of the model.

In view of the above-mentioned points, it is an object of the present invention to provide a technique that enables machine learning using appropriate learning data.

An illustrative image processing device of the present invention, which is an image processing device for generating learning data that is used for machine learning, includes a processor configured to obtain image data. The processor specifies an unprocessable region that is a region in which a predetermined process cannot be performed or a region in which the predetermined process is not performed, in an image region of the image data, and generates image data on which the predetermined process is performed in a region except the unprocessable region in the image region, as the learning data.

### BRIEF DESCRIPTION OF THE DRAWINGS

FIG. 1 is a block diagram illustrating a hardware structure of an image processing device.

FIG. 2 is a block diagram illustrating a functional structure of a control unit of the image processing device.

FIG. 3 is a diagram for explaining a traffic sign indicating no parking and a traffic sign indicating vehicle closure.

FIG. 4 is a diagram illustrating an example of a table stored in a storage unit.

FIG. 5 is a flowchart illustrating a flow of image processing performed by the image processing device.

FIG. 6 is a diagram illustrating schematically image data that is object of data augmentation.

FIG. 7A is a first schematic diagram for explaining a variation.

FIG. 7B is a second schematic diagram for explaining a variation.

FIG. 8 is a block diagram illustrating a structure of a learning system.

FIG. 9 is a block diagram illustrating a hardware structure of the image processing device.

FIG. 10 is a block diagram illustrating as functional structure of a processing unit of the image processing device.

FIG. 11 is a diagram illustrating an example of parameter values output from a parameter deriving section.

FIG. 12 is a flowchart illustrating a flow of a learnt method using data augmentation.

FIG. 13 is a flowchart illustrating a detailed example of the image processing illustrated in FIG. 12.

FIG. 14 is a flowchart illustrating a detailed example of as learning process illustrated in FIG. 12.

### DETAILED DESCRIPTION OF THE PREFERRED EMBODIMENTS

Hereinafter, illustrative embodiments of the present invention are described in detail with reference to the drawings.

### First Embodiment

<1. Image Processing Device>

FIG. 1 is a block diagram illustrating a hardware structure of an image processing device 10 according to a first embodiment of the present invention. The image processing device 10 is a device for generating learning data that is used for machine learning. The image processing device 10 may be constituted as a single device, or may be included in a learning device for allowing a model to learn using the learning data. Note that the model is preferably a model including a deep neural network, as a preferred configuration. In this embodiment, the model is a model that performs object detection. However, this is merely an example, and the model may be a model that performs image classification, or the like.

As illustrated in FIG. 1, the image processing device 10 includes a control unit 11 and a storage unit 12.

The control unit 11 is constituted of a processor, for example. The control unit 11 is configured to include for example an arithmetic integrated circuit, a random access memory (RAM), a read only memory (ROM), and the like. The arithmetic integrated circuit may be for example a central processing unit (CPU), a graphics processing unit (GPU), an accelerated processing unit (APU), or the like.

The storage unit 12 stores non-temporarily a computer readable program, data, and the like. The storage unit 12 includes a nonvolatile storage medium. The nonvolatile storage medium of the storage unit 12 is for example at least one type of a semiconductor memory, a magnetic medium, an optical medium, and the like. The storage unit 12 stores in a nonvolatile manner a program and data necessary for generating learning data that is used for the machine learning.

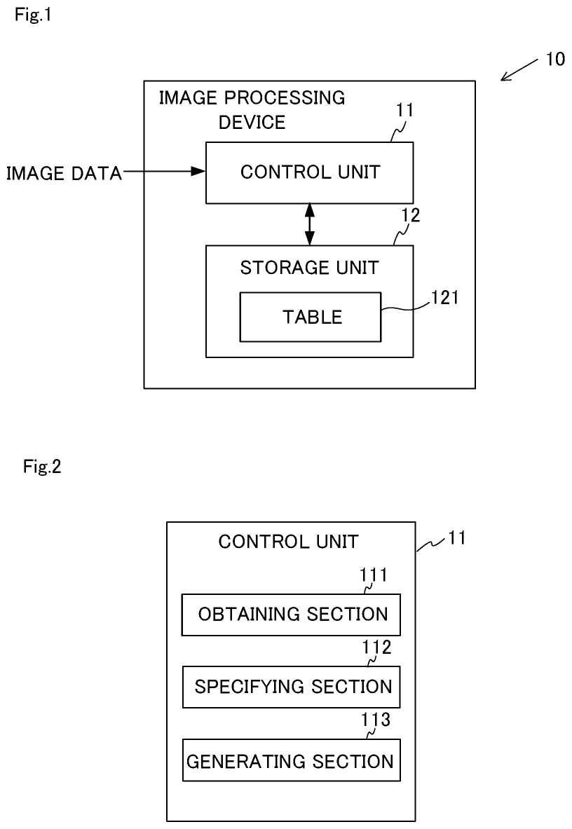

FIG. 2 is a block diagram illustrating a functional structure of the control unit 11 of the image processing device 10 according to the first embodiment of the present invention. Functions of the control unit 11 are realized by performing arithmetic processing in accordance with the program stored in the storage unit 12. As illustrated in FIG. 2, the control unit 11 of this embodiment includes, as its functions, an obtaining section 111, a specifying section 112, and a generating section 113. In other words, the image processing device 10 includes the obtaining section 111, the specifying section 112, and the generating section 113.

Note that at least one of the obtaining section 111, the specifying section 112, and the generating section 113 included in the control unit 11 may be made up of hardware such as an application specific integrated circuit (ASIC) or a field programmable gate array (FPGA). In addition, the obtaining section 111, the specifying section 112, and the generating section 113 are conceptual components. It may be possible to distribute a function performed by one component to a plurality of components, or to integrate functions of a plurality of components into one component.

The obtaining section 111 obtains image data. Specifically, the obtaining section 111 obtains image data from outside of its own device 10. In this embodiment, the image data itself is learning data (image for learning) that is used for the machine learning and is data with correct label. The image processing device 10 generates a new image for learning by processing an existing image for learning. The image processing device 10 performs so-called data augmentation (data extension) so as to increase the number of learning data.

The specifying section 112 specifies an unprocessable region in which a predetermined process cannot be performed, in an image region of the image data obtained by the obtaining section 111. In other words, the specifying section 112 specifies the unprocessable region that is a region in which a predetermined process is not performed. The predetermined process is a process included in an image processing method that is used in data augmentation. The image processing method that is used in data augmentation includes for example a color change process, a contrast change process, a brightness change process, a blurring process (process of producing a blurring effect), and the like. In this embodiment, the predetermined process is the color change process. Specifically, the predetermined process is an RGB shift. The RGB shift is a process of shifting ratio of red (R), green (G) and blue (B).

The unprocessable region includes an image of an object whose color information plays an important role. In other words, the unprocessable region includes an image of an object whose color information is used for specific evaluation criteria. With this structure, the color change process is not performed in the region having important color information. In other words, color information is maintained as it is, in a part of the image data having important color information for object recognition, and the color change process is performed in other parts so that the learning data can be generated using a data augmentation method.

Note that the specific evaluation criteria may be evaluation criteria related to traffic rules. In other words, the unprocessable region may include an image of an object whose color information is used for evaluation criteria related to traffic rules. With this structure, the learning data can be generated using the data augmentation method while avoiding that color information necessary for determination related to traffic rules is lost.

As the object whose color information is used for evaluation criteria related to traffic rules, there is a traffic signal, for example. For instance, a case where the traffic signal is red and a case where it is green have different signs in traffic rules, and therefore color information is important. Other than that, as the object whose color information is used for evaluation criteria related to traffic rules, there are specific traffic signs, license plates, lanes, and the like.

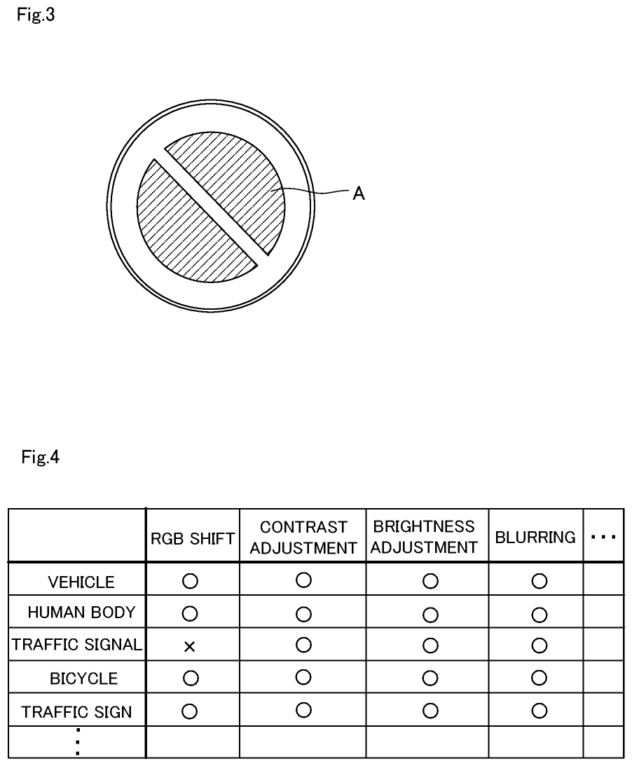

The specific traffic signs may include for example a traffic sign indicating no parking, and a traffic sign indicating vehicle closure. FIG. 3 is a diagram for explaining the traffic sign indicating no parking and the traffic sign indicating vehicle closure. In FIG. 3, the hatching area A has blue color in the traffic sign indicating no parking, while it has white color in the traffic sign indicating vehicle closure. The color of other areas is the same between the traffic sign indicating no parking and the traffic sign indicating vehicle closure. If performing data augmentation in which the color change process is performed uniformly in the entire region of the image including these traffic signs, the model after learning using the image for learning obtained by the data augmentation may cause deterioration in discrimination performance between the traffic sign indicating no parking and the traffic sign indicating vehicle closure. Therefore, it is preferred that the region including these traffic sign images be the unprocessable region, if discrimination between these traffic signs is required.

In addition, color of license plate is different between a private car and a commercial car, and further it is different between a standard-sized car and a light car. If performing data augmentation in which the color change process is performed uniformly in the entire region of the image including a license plate image, the model after learning using the image for learning obtained by the data augmentation may cause deterioration in recognition performance about a type of car. Therefore, it is preferred that the region including the license plate image be the unprocessable region, if recognition of a type of car using the license plate is required.

In addition, lanes include a white color lane and a yellow color lane. If performing data augmentation in which the color change process is performed uniformly in the entire region of the image including a lane image, the model after learning using the image for learning obtained by the data augmentation may cause deterioration in recognition performance about a type of lane. Therefore, it is preferred that the region it the lane image be the unprocessable region, if recognition of a type of lane is required.

In this embodiment, the specifying section 112 specifies the unprocessable region on the basis of a table 121 stored in advance in the storage unit 12. FIG. 4 is a diagram illustrating an example of the table 121 stored in the storage unit 12. The table 121 illustrated in FIG. 4 is a table that defines whether or not the data augmentation can be applied to each class of object. Specifically, image processing that is performed by the data augmentation is classified into a plurality of image processings, and classes of object and applicability or non-applicability of each image processing are defined. In FIG. 4, ∘ means that the image processing can be applied, while × means that the image processing cannot be applied.

Specifically in the example of the table 121 illustrated in FIG. 4, applicability or non-applicability of the color change process (RGB shift), the contrast change process (contrast adjustment), the brightness change process (brightness adjustment), or the blurring process to each class of object is defined. In other words, the specifying section 112 specifies the unprocessable region based on the table 121 that indicates a relationship between applicability or non-applicability of a predetermined process and a class of object. With this structure, it is possible to avoid complicated process for specifying the unprocessable region.

For instance, when the color change process is performed in the data augmentation, the region of the image including the traffic signal image is determined to be the unprocessable region based on the table 121 illustrated in FIG. 4. Further, the region of the image including the traffic signal image is specified based on correct label information attached to the image data, and the specified region is recognized as the unprocessable region.

In this embodiment, the region including the traffic signal image is specified by information in a bounding box included in the correct label information. In other words, the unprocessable region is a region enclosed by the bounding box indicating position of the object on which the predetermined process cannot be performed. In other words, the unprocessable region is a region enclosed by the bounding box indicating position of the object on which the predetermined process is not performed. With this structure of enclosing the unprocessable region with the bounding box, data quantity for specifying the unprocessable region can be reduced, and a load necessary for preparing for the image data or a processing load of the image processing device 10 can be reduced.

Note that the unprocessable region may be other than the region enclosed by the bounding box. If annotation for each pixel (segmentation label) is given as the correct label, the region of the image including the traffic signal image may be specified in pixel unit.

The generating section 113 generates image data on which the predetermined process is performed in a region except the unprocessable region in the image region of the image data obtained by the obtaining section 111, as the learning data. With this structure, data extension (data augmentation) of the image data can be performed while remaining pixel information that is important for object recognition, and the learning data for the machine learning can be generated appropriately. The number of the learning data is increased by the data augmentation, and hence overtraining of the model can be suppressed.

The unprocessable region may be remained as the original image data without the image processing. In other words, information of the unprocessable region in the learning data generated by the generating section 113 may be the same as information of the image data obtained by the obtaining section 111. With this structure, the learning data can be generated using the data augmentation without complicated process.

Note that the unprocessable region may be processed by an image processing method other than the predetermined process, which is used in the data augmentation method. For instance, if the predetermined process is the color change process, the contrast change process, the brightness change process, or the like may be performed in the unprocessable region. In other words, information of the unprocessable region in the learning data generated by the generating section 113 may be different from information of the image data obtained by the obtaining section 111.

<2. Image Processing Method>

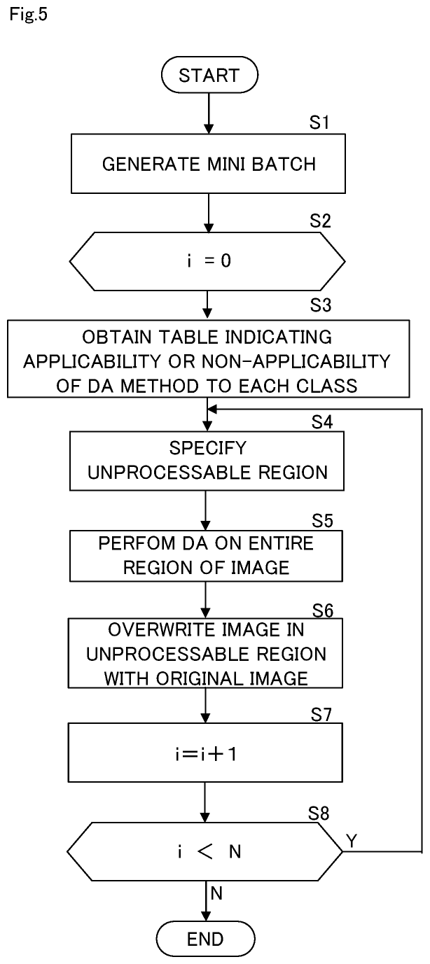

FIG. 5 is a flowchart illustrating a flow of the image processing performed by the image processing device 10 according to the first embodiment of the present invention. Here, a case where the image processing device 10 is included in the learning device that allows the model to learn is exemplified and described.

In Step S1, the obtaining section 111 samples N data from existing learning data (image for learning) and generates a mini batch. After the process in Step S1 is finished, the process flow proceeds to next Step S2.

In Step S2, variable i is set to zero. The variable i is incremented by one every time when the learning data is generated by the data augmentation. After the process in Step S2 is finished, the process flow proceeds to next Step S3.

In Step S3, the table that indicates whether or not the data augmentation (DA) method can be applied to each class is obtained. In this example, the table is the table 121 described above with reference to FIG. 4, and the table 121 is read from the storage unit 12. Note that in the table 121 illustrated in FIG. 4, the RGB shift, the contrast adjustment, the brightness adjustment, and the blurring process are detailed examples of the data augmentation method. The vehicle, a human body, the traffic signal, a bicycle, and the traffic sign are detailed examples of the class of object. After the process in Step S3 is finished, the process flow proceeds to next Step S4.

In Step S4, the unprocessable region is specified, on the basis of the table 121 obtained in Step S3 and the data augmentation method to be applied, by the specifying section 112. One type of the data augmentation method or a plurality of types of the data augmentation methods may be applied. For instance, the data augmentation method to be applied is determined at start point of the process illustrated in FIG. 5. Here, a case where the data augmentation method to be applied is the RGB shift (color change process) is supposed and described.

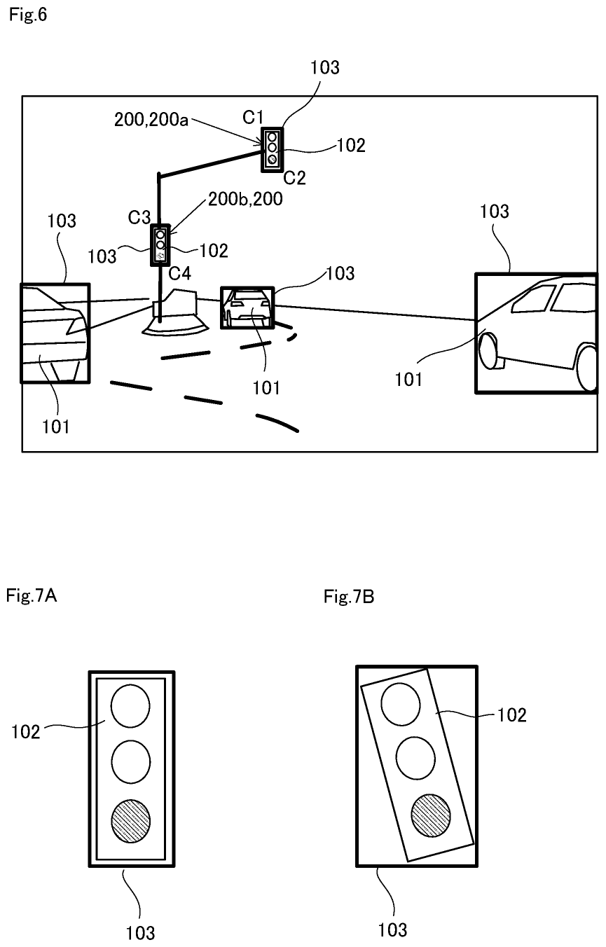

In this example, the specifying section 112 determines that a predetermined region including the traffic signal is the unprocessable region in accordance with the table 121. The specifying section 112 uses information of the correct label included in the image data that is object of the data augmentation, so as to specify the predetermined region including the traffic signal, and sets the specified predetermined region to the unprocessable region. This is further described in detail with reference to FIG. 6.

FIG. 6 is a diagram illustrating schematically image data that is object of the data augmentation. The image data illustrated in FIG. 6 includes images of a vehicle 101 and a traffic signal 102 that are objects of the object detection. The image data includes, as the information of the correct label, position information and class information of the vehicle 101 and the traffic signal 102. The position information of the vehicle 101 and the traffic signal 102 are given by a bounding box 103 in this example. The specifying section 112 specifies the predetermined region including the traffic signal 102 by using the bounding box 103 indicating position of the traffic signal 102 included in the information of the correct label. More specifically, the specifying section 112 sets the predetermined region including the traffic signal 102 to the region enclosed by the bounding box 103 indicating position of the traffic signal 102. In other words, the region enclosed by the bounding box 103 indicating position of the traffic signal 102 is set as an unprocessable region 200. In the example illustrated in FIG. 6, there are two traffic signals 102, and two unprocessable regions 200 are specified.

Note that, as the bounding box 103 is a rectangular frame, the unprocessable region 200 is specified by coordinates of one corner position and its diagonal corner position of the bounding box 103 in this example. For instance, a first unprocessable region 200a is specified by coordinates of an upper left corner C1 and a lower right corner C2 of the bounding box 103. In addition, a second unprocessable region 200b is specified by coordinates of an upper left corner C3 and a lower right corner C4 of the bounding box 103. The coordinates of the corners C1, C2, C3, and C4 are expressed as XY coordinates. Using this structure of specifying the unprocessable region 200 with coordinates of corners of the bounding box 103, processing load can be reduced.

After the process in Step S4 is finished, the process flow proceeds to next Step S5. In Step S5, the data augmentation is performed on the image data to be processed. In this example, the RGB shift is performed in the entire region of the image. After the process in Step S4 is finished, the process flow proceeds to next Step S6.

In Step S6, the image in the unprocessable region is overwritten with the image of the corresponding region in the original image data. In other words, the image of the unprocessable region is remained to be the image of the original image data. In this way, the learning data after the data augmentation is generated. In the example illustrated in FIG. 6, the generated learning data is the image data after performing the data augmentation except for the predetermined region including the traffic signal 102 (i.e., two unprocessable regions 200a and 200b). The predetermined region including the traffic signal 102 maintains color information of the original image without the RGB shift performed. After the process in Step S6 is finished, the process flow proceeds to next Step S7.

Note that the image of the unprocessable region is the same image of the original image data in this embodiment, but this is merely an example. As described above, the image of the unprocessable region may be for example an image after performing the contrast adjustment or the brightness adjustment on the image of the original image data.

In Step S7, the variable i is incremented by 1. This means that the number of data after finishing the process of generating the learning data is increased by one. After the process in Step S7 is finished, the process flow proceeds to next Step S8.

In Step S8, it is checked whether or not the variable i is smaller than N that is the number of data to be processed. If the variable i is smaller than N (Yes in Step S8), the process of generating the learning data is not finished for all data that constitute the mini batch, and therefore the process flow returns to Step S4 so that the processes of Step S4 and after are repeated for a new image data. If the variable i has reached N (No in Step S8), the process of generating the learning data is finished for all data that constitute the mini batch, and therefore the processes illustrated in FIG. 5 are finished. The generated plurality of learning data are used as the learning data of one mini batch for allowing the model to learn.

Note that in the example described above, the data augmentation (color change process) is first performed in the entire region of the image, and afterwards the unprocessable region 200 is overwritten with the original image, but this is merely an example. It may be possible to perform the data augmentation (color change process) only in a region except the unprocessable region 200 in the entire region of the image, so that the process of overwriting the original image is not performed afterwards.

In addition, in the example described above, the region enclosed by the bounding box 103 indicating the traffic signal 102 is regarded as the unprocessable region 200, but this is merely an example. As described above, it may be possible to specify the region of the image including the traffic signal 102 in pixel unit, and to regard the specified region as the unprocessable region. This is described below using an example illustrated in FIGS. 7A and 7B.

For instance, as illustrated in FIG. 7B, the traffic signal 102 may be inclined in the image. In this case, the bounding box 103 indicating position of the traffic signal 102 is larger than that in the case where the traffic signal 102 is not inclined (see FIG. 7A). Therefore, if the traffic signal 102 is inclined as illustrated in FIG. 7B, and if the region enclosed by the bounding box 103 is regarded as the unprocessable region, the region in which the data augmentation is not performed though it should be performed is increased. In this regard, if the region including the traffic signal 102 is specified in pixel unit and regarded as the unprocessable region, it can be avoided that the regions adjacent to the traffic signal 102 are unnecessarily included in the unprocessable region. Therefore, the data augmentation can be performed more appropriately in the region where the data augmentation should be performed.

### Second Embodiment

<1. Learning System>

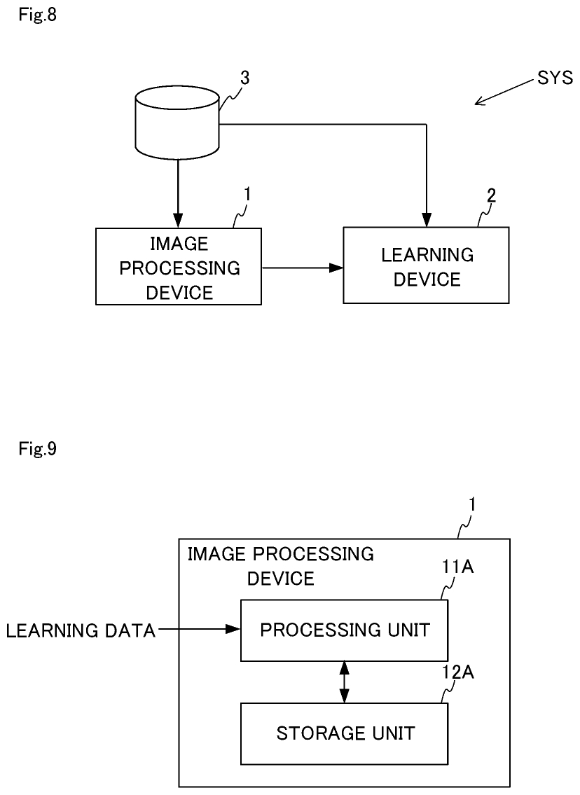

FIG. 8 is a block diagram illustrating a structure of a learning system SYS according to a second embodiment of the present invention. As illustrated in FIG. 8, the learning system SYS includes an image processing device 1 and a learning device 2. Note that in this embodiment, learning means the machine learning.

A learning data set 3 illustrated in FIG. 8 includes a plurality of learning data for the machine learning. The learning data is specifically image data with correct label. The learning data set 3 is a group of data prepared in advance. The learning data set 3 may be stored in a storage medium such as a hard disk. In this case, the learning data included in the learning data set 3 may be read out of the storage medium by the image processing device 1 and the learning device 2. Note that the learning data set 3 may be manually input to the image processing device 1 and the learning device 2.

The image processing device 1 processes the learning data (image data) included in the learning data set 3. In this embodiment, the process performed by the image processing device 1 includes the data augmentation (data extension) for extending the image data. Through the data augmentation, new learning data different from the learning data prepared in advance is generated. In other wards, through processing of the learning data by the image processing device 1, the number of learning data can be increased. A detailed structure of the image processing device 1 will be described later.

The learning device 2 performs learning of the model to be learned (hereinafter, referred to as a learning object model). Note that the learning object model preferably has a structure including a deep neural network. The learning object model may be for example a model for performing the object detection, a model for performing the image classification, or the like.

In this embodiment, the learning device 2 uses the image data included in the learning data set 3 as it is, so as to learn the learning object model. In addition, the learning device 2 uses the image data obtained after the image processing device 1 processes the image data included in the learning data set 3, so as to learn the learning object model.

In other words, the learning device 2 leans the learning object model using the processed image data obtained after the data augmentation is performed on the image data. As described later, in this embodiment, the data augmentation can be appropriately performed on the image data, and hence the learning device 2 can use a large quantity of appropriate learning data so as to perform the learning. As a result, performance of a learned model obtained after learning using the learning device 2 can be improved.

Note that in this embodiment, the image processing device 1 is separate from the learning device 2. However, this configuration is merely an example. The image processing device 1 may be included in the learning device 2. In addition, in this embodiment, the image processing device 1 performs the data augmentation, but this is merely an example. The image processing device 1 may perform a preprocess necessary for performing the data augmentation on the image data, and the data augmentation may be performed by the learning device 2.

<2. Image Processing Device>

FIG. 9 is a block diagram illustrating a hardware structure of the image processing device 1 according to the second embodiment of the present invention. As illustrated in FIG. 9, the image processing device 1 includes a processing unit 11A. The learning data included in the learning data set 3 is input to the processing unit 11A. The processing unit 11A processes the input learning data. In other words, the processing unit 11A processes image data for machine learning.

The processing unit 11A includes a processor that performs arithmetic processing and the like. The processor may include a CPU, for example. In addition, the processor may include a CPU and a GPU, for example. The processing unit 11A may be made up of a single processor or may be made up of a plurality of processors. If it is made up of a plurality of processors, the processors should be connected to each other in a communicable manner.

As illustrated in FIG. 9, the image processing device 1 further includes a storage unit 12A. The storage unit 12A stores non-temporarily a computer readable program, data, and the like. In this embodiment, the storage unit 12A also stores learned models obtained after the machine learning. The storage unit 12A includes a nonvolatile storage medium. The nonvolatile storage medium may be made up of at least one type of a semiconductor memory, a magnetic medium, an optical medium, and the like, for example.

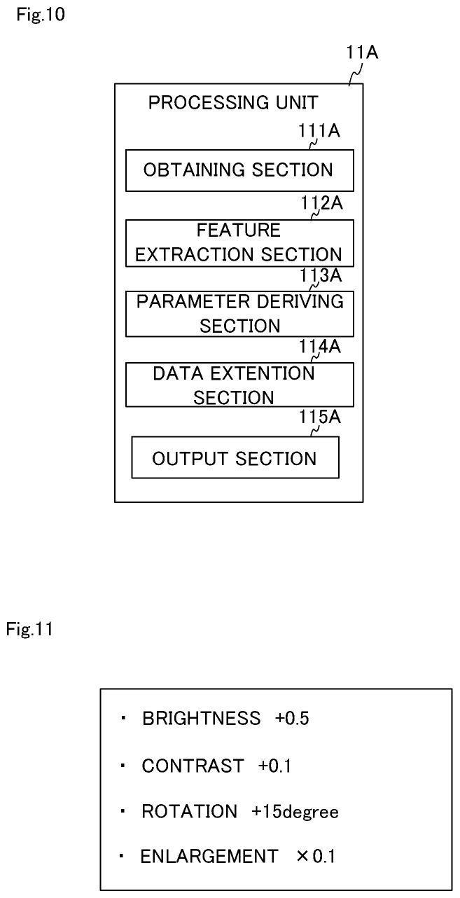

FIG. 10 is a block diagram illustrating a functional structure of the processing unit 11A of the image processing device 1 according to the second embodiment of the present invention. Functions of the processing unit 11A are realized by a processing unit such as a CPU performing arithmetic processing according to the program stored in the storage unit 12A. As illustrated in FIG. 10, the processing unit 11A includes, as its functions, an obtaining section 111A, a feature extraction section 112A, a parameter deriving section 113A, a data extension section 114A, and an output section 115A.

Note that at least one of the obtaining section 111A, the feature extraction section 112A, the parameter deriving section 113A, the data extension section 114A, and the output section 115A of the processing unit 11A may be made up of hardware such as ASIC, FPGA, or GPU. In addition, the obtaining section 111A, the feature extraction section 112A, the parameter deriving section 113A, the data extension section 114A, and the output section 115A are conceptual components. It may be possible to distribute a function performed by one component to a plurality of components, or to integrate functions of a plurality of components into one component.

The obtaining section 111A obtains the learning data included in the learning data set 3. Specifically, the obtaining section 111A obtains the image data as the learning data. The obtaining section 111A may obtain the plurality of learning data included in the learning data set 3 as a batch or may obtain them separately at different timings. The obtaining section 111A may obtain the plurality of learning data as a batch so as to generate the mini batch.

The feature extraction section 112A extracts feature quantity from the obtained image data. The feature extraction section 112A extracts the feature quantity for each image data. Specifically, the feature extraction section 112A uses the learned model for extracting the feature quantity from the image data. The learned model is for example a learned model obtained by performing the machine learning such as deep learning.

In this embodiment, the feature extraction section 112A uses a learned convolutional neural network (CNN). When the image data is input, the feature extraction section 112A that uses the learned CNN performs convolution and pooling on the input image data, so as to output a feature map. Note that the feature extraction section 112A outputs the feature map for each input image data.

The parameter deriving section 113A uses the feature quantity extracted by the feature extraction section 112A, so as to derive parameter values suitable for performing the data augmentation of the image data from which the feature quantity has been extracted. The parameter deriving section 113A derives the parameter values for data augmentation for each image data. In this embodiment, the parameter deriving section 113A and the feature extraction section 112A constitute a CNN model. The parameter deriving section 113A includes a learned fully connected layer.

In this embodiment, feature map data (two-dimensional data) output from the feature extraction section 112A is expanded into one-dimensional data and is input to the parameter deriving section 113A. When the feature map data is input, the parameter deriving section 113A derives the parameter values suitable for performing the data augmentation to extend the image data and outputs the derived parameter values.

By the data augmentation, for example, color tone conversion, affine transformation, or the like is performed on the image data. The color tone conversion may include for example color conversion, brightness conversion, and contrast conversion, or at least two of these conversions. In addition, the affine transformation may include for example rotation, flip horizontal, enlargement, reduction, and translation, or at least two of these conversions. In addition, for example, by the data augmentation, both the color tone conversion and the affine transformation may be performed.

The parameter deriving section 113A derives and outputs the parameter values of types that are set as parameters for the data augmentation in advance. FIG. 11 is a diagram illustrating an example of the parameter values output by the parameter deriving section 113A. In the example illustrated in FIG. 11, the types of parameters derived by the parameter deriving section 113A are set in advance to brightness, contrast, rotation, and enlargement. Therefore, the parameter deriving section 113A derives and outputs, as the parameter values that are used for the data augmentation, parameter value of brightness, parameter value of contrast, parameter value of rotation, and parameter value of enlargement.

Note that the parameter deriving section 113A derives various types of the parameter values defined in design stage, within a set range. In addition, in the example illustrated in FIG. 11, there are four types of parameters derived by the parameter deriving section 113A, but this is merely an example. The parameter deriving section 113A may derive a plurality of parameters other than four parameters. In addition, the parameter deriving section 113A may derive a single parameter.

Learning of the fully connected layer constituting the parameter deriving section 113A may be performed as follows, for example. First, the image data with correct label is input to the feature extraction section 112A (learned model). Next, the feature map data extracted by the feature extraction section 112A is input to the fully connected layer as learning object. Using the parameter values for the data augmentation output from the fully connected layer as learning object, the data augmentation is performed on the image data. Note that the image data on which the data augmentation is performed is the same as the image data from which the feature map has been extracted. Using the image data obtained by the data augmentation, an inference process is performed with a learned object recognition model, and an error in an inference result with respect to the correct label described above is determined. The process described above is performed for many image data, and the parameters of the fully connected layer as learning object are optimized so that the error in the inference result with respect to the correct label becomes small. In this way, the learned fully connected layer is obtained.

With reference to FIG. 10 again, the data extension section 114A uses the parameter values derived by the parameter deriving section 113A so as to perform the data augmentation. Note that the data augmentation is performed for each image data. By performing the data augmentation on the image data prepared as the learning data, the number of learning data can be increased.

Note that the data augmentation may be performed on the entire image, or may be performed on a specific object included in the image. In other words, the data augmentation may be performed on at least a part of the image. In addition, the process by the data extension section 114A may be performed by the learning device 2. In other words, the image processing device 1 may not include the data extension section 114A.

The output section 115A outputs to the learning device 2 the image data after performing the data augmentation (processed image data). The output section 115A may output the processed image data to the learning device 2 every time when the processed image data after the data augmentation is generated. Alternatively, the output section 115A may output to the learning device 2 a certain number of processed image data after the data augmentation as a batch when they are accumulated.

Note that, if the data extension section 114A is disposed in the learning device 2, the output section 115A may output the parameter values for the data augmentation to the learning device 2.

Similarly to the image processing device 1, the learning device 2 includes the processing unit and the storage unit, and learns the learning object model for performing object detection, image classification, or the like, for example. Note that the learning data that the learning device 2 uses for leaning include both the image data included in the learning data set 3 and the processed image data obtained after performing the data augmentation on the image data included in the learning data set 3.

As understood from above, the processing unit 11A processes the image data for the machine learning and derives the parameter values that are used for the data augmentation to extend the image data. With this structure, the parameter values that are used for data augmentation can be determined more appropriately than the conventional structure, in which the parameter values that are used for the data augmentation are selected randomly without relation to image status. In other words, it is possible to reduce possibility of generating an image that cannot occur actually by the data augmentation, and learning of the learning object model can be performed appropriately.

Specifically, the processing unit 11A extracts the feature quantity from the input image data, and uses the feature quantity for deriving the parameter values. With this structure, appropriate parameter values for the data augmentation based on image data status can be derived using the learned model after performing the machine learning.

In addition, a plurality of image data are input to the processing unit 11A, and the processing unit 11A derives the parameter values that are used for the data augmentation for each image data. With this structure, the parameter value suitable for the data augmentation can be obtained for each image. The number of learning data can be increased appropriately from each of the plurality of learning data, and various types of data suitable for learning can be obtained.

In addition, in this embodiment, the processing unit 11A uses the derived parameter values so as to generate the processed image data obtained by performing the data augmentation on the image data. In this embodiment, the parameters for the data augmentation can be determined appropriately depending on image status, and hence the image processing device 1 that performs the data augmentation can increase the number of the image data suitable for leaning.

<3. Learning Method>

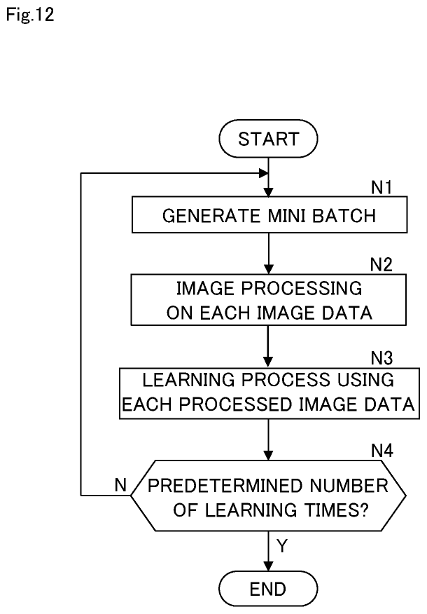

FIG. 12 is a flowchart illustrating a learning method using the data augmentation according to the second embodiment of the present invention. The learning method of this embodiment is a method of performing the machine learning of a learning object model. The learning object model is for example a model for performing of detection, a model for performing image classification, or the like.

In Step N1, the processing unit 11A of the image processing device 1 generates the mini batch. The mini batch is generated by sampling from the learning data set 3 a predetermined number of the learning data (image data with correct label). The number of the learning data constituting the mini batch is obtained for example by dividing the learning data (number of data) included in the learning data set 3 by a preset number of learning times. After the mini batch is generated, the process flow proceeds to next Step N2.

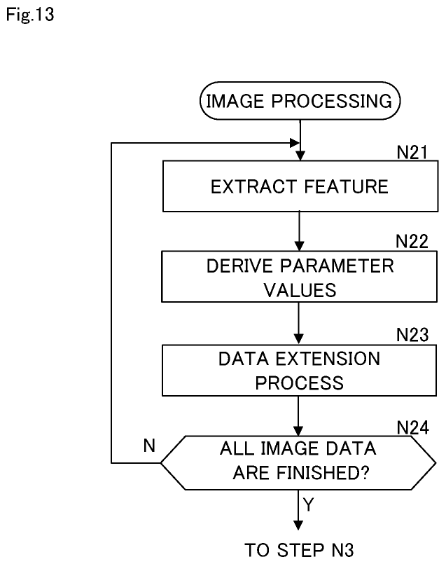

In Step N2, the processing unit 11A of the image processing device 1 performs image processing on each image data constituting the mini batch. After the it processing is finished, the process flow proceeds to next Step N3. The image processing is described below in detail with reference to FIG. 13. FIG. 13 is a flowchart illustrating a detailed example of image processing illustrated in FIG. 12.

In Step N21, the feature extraction section 112A constituted using the learned model extracts the feature quantity from one image data. Specifically, the feature extraction section 112A extracts the feature map. After the feature quantity is extracted, the process flow proceeds to next Step N22.

In Step N22, the parameter deriving section 113A constituted using the learned model uses the extracted feature quantity so as to derive the parameter values for data augmentation. Specifically, when the feature map data is input, the parameter deriving section 113A derives the parameter values for data augmentation suitable for the image data from which the feature map has been extracted. After the parameter values are derived, the process flow proceeds to next Step N23.

In Step N23, the data extension section 114A uses the derived parameter values so as to perform the data extension process (data augmentation). In this way, the new learning data is generated. After the new image data is obtained by the data augmentation, the process flow proceeds to next Step N24.

In Step N24, the processing unit 11A determines whether or not the data augmentation is finished for all image data constituting the mini batch. If the data augmentation is finished for all image data (Yes in Step N24), the process flow proceeds to Step N3 in FIG. 12. If the data augmentation is not finished for all image data (No in Step N24), the process flow returns to Step N21 and the processes of Step N21 and after are repeated.

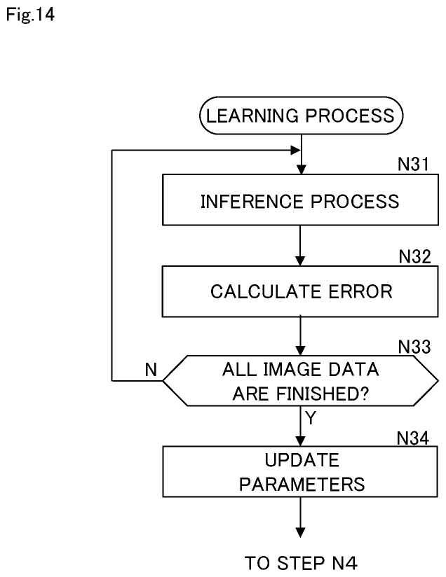

With reference to FIG. 12 again, in Step N3, the learning device 2 performs a learning process using each processed image data that is the image data after performing the data augmentation on each image data. After the learning process is finished, the process flow proceeds to next Step N4. The learning process is described below in detail with reference to FIG. 14. FIG. 14 is a flowchart illustrating a detailed example of the learning process illustrated in FIG. 12.

In Step N31, a processing unit (not shown) of the learning device 2 performs the inference process using one processed image data. For instance, if the learning object model is a model for the object detection, the inference process may be performed using a known R-CNN, Fast R-CNN, Faster R-CNN, YOLO, SSD, or the like. In addition, if the learning object model is a model for the image classification for example, the inference process may be performed using a known AlexNet, VGG, ResNet, or the like. After the inference process is finished, the process flow proceeds to next Step N32.

In Step N32, the processing unit of the learning device 2 calculates error (loss) in the inference result of the inference process with respect to the correct label (obtained from the learning data set 3). The error is determined by a preset function such as an L2 loss or a KL divergence, for example. After the error is calculated, the process flow proceeds to next Step N33.

In Step N33, the processing unit of the learning device 2 determines whether or not the inference process and the error calculation are finished for all processed image data obtained from the image data constituting the mini batch. If the inference process and the error calculation are finished for all processed image data (Yes in Step N33), the process flow proceeds to next Step N34. If the inference process and the error calculation are not finished for all processed image data (No in Step N33), the process flow returns to Step N31, and the processes of Step N31 and after are repeated.

In Step N34, the processing unit of the learning device 2 uses the calculation result of error obtained by the inference process of each processed image data, so as to update the parameters of the learning object model. Specifically, the parameters may be updated using a known error back propagation method. After the updating process of the parameters of the learning object model is finished, the process flow proceeds to Step N4 illustrated in FIG. 12.

With reference to FIG. 12 again, in Step N4, the processing unit of the learning device 2 determines whether or not a predetermined number of learning times has been reached. The predetermined number of learning times is for example a number of times to finish the process of all learning data constituting the learning data set 3. If the predetermined number of learning times has not been reached (No in Step N4), the process flow returns to Step N1, and the above processes of Step N1 and after are repeated. If the predetermined number of learning times has been reached (Yes in Step N4), the learning method using the data augmentation illustrated in FIG. 12 is finished.

Note that the learning of the learning object model may be finished when the process illustrated in FIG. 12 is finished. However, the learning of the learning object model may be finished after the process illustrated in FIG. 12 is performed a plurality of times. In addition, in the process illustrated in FIG. 12, the learning object model is learned using only the processed image data after performing the data augmentation. It is preferred to finish the leaning of the learning object model after performing both the leaning using the processed image data and the leaning using the image data before performing the data augmentation.

As understood from the above description, the learning method of this embodiment includes a parameter deriving step of deriving parameter values that are used for data augmentation to extend image data for the machine learning, by using the learned model to which the image data is input. With this structure, the parameter values that are used for data augmentation can be determined more appropriately than the conventional structure, in which the parameter values that are used for the data augmentation are selected randomly without relation to image status. In other words, it is possible to reduce possibility of generating an image that cannot occur actually by the data augmentation, and learning of the learning object model can be performed appropriately.

In addition, the learning method of this embodiment further includes a processed image generation step of generating processed image data by performing data augmentation on image data using the derived parameter values, and a learning step of learning the learning object model using the processed image data. As described above, the data augmentation can be performed appropriately in this embodiment, and hence learning of the learning object model can be performed using plenty of appropriate learning data. Therefore, improvement in performance of the learned model can be expected.

<<Notes>>

Various technical features disclosed in this specification are not limited to those described in this embodiment described above, but can be modified variously without deviating from the spirit of this technical invention. In other words, the embodiment described above is merely an example in every aspect and should not be interpreted as a limitation. The technical scope the present invention is defined not by the above description of the embodiment but by the claims, and it should be understood to include all modifications within meanings and scope equivalent to the claims. In addition, the plurality of embodiments and variations described in this specification may be appropriately combined and implemented to the extent possible.

The scope of this embodiment also includes a computer program and a computer readable nonvolatile recording medium storing the program, which allows a computer (processor) to execute functions of the control unit 11 or the processing unit 11A of the image processing device 1 or 10 described above. In addition, the scope of this embodiment also includes a computer program and a computer readable nonvolatile recording medium storing the program, which allows a computer (processor) to execute the image processing method and the learning method described above.

The structure of the first embodiment and the structure of the second embodiment, which are described above, may be combined. Specifically, the control unit 11 first performs a process of specifying the unprocessable region, which is a region in which a predetermined process cannot be performed or a region in which the predetermined process is not performed, in the image region of the image data. Here, the predetermined process is the data augmentation. A region except the unprocessable region in the image region of the image data is to be a region in which the data augmentation is performed. The control unit 11 derives parameter values that are used for data augmentation for the region in which the data augmentation is performed. The parameter values are derived from the feature quantity that is extracted from the image data. The control unit 11 uses the derived parameter values so as to generate the image data on which the data augmentation is performed as the learning data, for the region except the unprocessable region in the image region.

What is claimed is:

1. An image processing device for generating learning data to be used for machine learning, the device comprising a processor configured to obtain image data, wherein
the processor specifies an unprocessable region as a region in which a predetermined process cannot be performed or a region in which the predetermined process is not performed, in an image region of the image data, and
the processor generates image data on which the predetermined process is performed in a region except the unprocessable region in the image region, as the learning data.

2. The image processing device according to claim 1, wherein
the predetermined process is a color change process, and
the unprocessable region includes an image of an object whose color information is used for specific evaluation criteria.

3. The image processing device according to claim 2, wherein the specific evaluation criteria is evaluation criteria related to traffic rules.

4. The image processing device according to claim 1, wherein the processor specifies the unprocessable region on the basis of a table indicating a relationship between applicability or non-applicability of the predetermined process and class of object.

5. The image processing device according to claim 4, wherein the unprocessable region is a region enclosed by a bounding box indicating position of object to which the predetermined process cannot be applied or is not applied.

6. The image processing device according to claim 1, wherein information of the unprocessable region in the learning data generated by the processor is the same as information of the image data obtained by the processor.

7. The image processing device according to claim 1, wherein
the predetermined process is data augmentation, and
the processor derives a parameter value to be used for the data augmentation that is performed in the region except the unprocessable region in the image region of the image data.

8. An image processing method for generating learning data to be used for machine learning, the method comprising:
an obtaining step of obtaining image data;
a specifying step of specifying an unprocessable region as a region in which a predetermined process cannot be performed or a region in which the predetermined process is not performed, in an image region of the image data; and
a generation step of generating image data on which the predetermined process is performed in a region except the unprocessable region in the image region, as the learning data.

9. The image processing method according to claim 8, wherein
the predetermined process is data augmentation, and
the method further includes a deriving step of deriving a parameter value to be used for the data augmentation to be performed in the region except the unprocessable region in the image region of the image data.

10. An image processing device comprising a processor for processing image data for machine learning, wherein
the processor processes the image data so as to derive a parameter value to be used for data augmentation to extend the image data.

11. The image processing device according to claim 10, wherein the processor extracts feature quantity from the image data input, so as to derive the parameter value using the feature quantity.

12. The image processing device according to claim 10, wherein
a plurality of image data are input to the processor, and
the processor derives the parameter value for each image data.

13. The image processing device according to claim 10, wherein the processor uses the derived parameter value so as to generate processed image data after performing the data augmentation on the image data.

14. A learning system comprising:
the image processing device. according to claim 10; and
a learning device for learning a learning object model using processed image data of performing the data augmentation on the image data.
